(19) United States
(12) Patent Application Publication
(10) Pub. No.: US 2010/0272903 A1
(43) Pub. Date: Oct. 28, 2010

(54) CATALYTIC SURFACE ACTIVATION METHOD FOR ELECTROLESS DEPOSITION

(75) Inventors: Jeong-Hoon Byeon, Chungcheongnam-do (KR); Jae-Hong Park, Seoul (KR); Ki-Young Yoon, Seoul (KR); Jung-Ho Hwang, Seoul (KR)

Correspondence Address: RABIN & Berdo, PC, 1101 14TH STREET, NW, SUITE 500, WASHINGTON, DC, 20005, US

(73) Assignee: INDUSTRY-ACADEMIC COOPERATION FOUNDATION, YONSEI UNIVERSIY, Seoul (KR)

(21) Appl. No.: 12/831,217

(22) Filed: Jul. 6, 2010

Related U.S. Application Data
(62) Division of application No. 11/767,178, filed on Jun. 22, 2007.

(30) Foreign Application Priority Data
Jan. 5, 2007 (KR) 10-2007-0001631

(51) Int. Cl. B05D 3/10

(52) U.S. Cl. 427/305; 977/902

(57) ABSTRACT

Provided is a catalytic surface activation method for electroless deposition comprising a metallic aerosol nanoparticle generation step of generating metallic aerosol nanoparticles, which act as plating initiation catalyst; a metallic aerosol nanoparticle fixation step of fixing the resultant metallic aerosol nanoparticles on a plating surface; and an electroless deposition step of impregnating the material to be plated in an electroless deposition solution to form a plating layer on the plating surface on which the metallic aerosol nanoparticles have been fixed. The catalytic surface activation method for electroless deposition of the present invention is applicable to large-scale plating with simple process and superior applicability, improves the plating characteristics with little impurity generation, requires no post-treatment process for removing impurities and is environment-friendly with no wastewater generation by directly fixing metallic aerosol nanoparticles on the material to be plated.

### CROSS-REFERENCE TO RELATED APPLICATIONS

This is a first of three contemporaneously filed divisional applications of copending U.S. application Ser. No. 11/767,178, filed Jun. 22, 2007, the disclosure of which is incorporated herein by reference. This application claims the priority of Korean Patent Application No. 10-2007-0001631 filed on Jan. 5, 2007, in the Korean Intellectual Property Office, the disclosure of which is incorporated herein by reference.

### BACKGROUND OF THE INVENTION

(a) Field of the Invention

The present invention relates to a catalytic surface activation method for electroless deposition, more particularly to a catalytic surface activation method for electroless deposition using metal nanoparticles as plating initiation catalyst.

(b) Description of the Related Art

Mainly, a two-step Sn sensitization and Pd catalyzation or a one-step Sn—Pd activation is carried out in solution to attach the plating initiation catalyst for electroless deposition on the surface of the material to be plated. However, since the aforesaid processes take place in solution, there remains the problem of the generation of wastewater in large quantity and the loss of expensive catalysts (Pd, Pt, Au, Ag, and so forth).

Tin (Sn) is required to deposit the Pd²⁺ ions in solution as Pd, but it is of no use in the final electroless deposition process in which the deposited Pd is used as initiation catalyst. The Sn component has to be removed after the deposition of Pd, because it may impair the purity of plating if it remains during the electroless deposition process.

Thus, researches on simple and environment-friendly catalytic activation processes are in progress. Of recent years, such processes as sputtering, laser ablation, UV irradiation, plasma surface treatment, etc. have been developed. However, these processes require ultra-low pressure, ultra-high temperature or other critical environment for successful catalytic activation. In addition, they are inadequate for large-scale plating and show worse plating characteristics than the former techniques. Further, the processes are complicated and may be incompatible with other processes.

### SUMMARY OF THE INVENTION

The present invention has been made to solve this problem and an object of the present invention is to provide a catalytic surface activation method for electroless deposition which is applicable to large-scale plating with simple process and superior applicability, improves the plating characteristics with little impurity generation, requires no post-treatment process for removing impurities and is environment-friendly with no wastewater generation by directly fixing metallic aerosol nanoparticles on the material to be plated.

Other objects and advantages of the present invention will be described below and become evident by the embodiments of the present invention. The objects and advantages of the present invention can be realized through the means set forth in the claims and combinations thereof.

### DESCRIPTION OF THE DRAWINGS

FIG. 1 is a flowchart illustrating the catalytic surface activation method for electroless deposition according to an embodiment of the present invention.

FIGS. 2 to 5 illustrate the first to fourth embodiments of the metallic aerosol nanoparticle generation step in FIG. 1.

FIGS. 6 to 9 illustrate the first to third embodiments of the metallic aerosol nanoparticle fixation step in FIG. 1.

FIG. 10 illustrates the hot pressing step in FIG. 1.

FIGS. 11 to 13 illustrate the first to third embodiments of the fixation improving agent treatment step that may be included in the method of FIG. 1.

FIGS. 14 and 15 illustrate the plating surface treatment step that may be included in the method of FIG. 1.

### DETAILED DESCRIPTION OF THE PREFERRED EMBODIMENTS

To attain the aforesaid object, the catalytic surface activation method for electroless deposition of the present invention comprises; a metallic aerosol nanoparticle generation step of generating metallic aerosol nanoparticles, which act as plating initiation catalyst; a metallic aerosol nanoparticle fixation step of fixing the resultant metallic aerosol nanoparticles on the plating surface; and an electroless deposition step of impregnating the material to be plated in an electroless deposition solution and forming a plating layer on the plating surface on which the metallic aerosol nanoparticles are fixed.

The metallic aerosol nanoparticle generation step of the present invention may comprise a metallic aerosol nanoparticle forming step in which a high voltage is applied between two metal electrodes to generate a spark and the metal components of the metal electrodes are vaporized by the heat generated from the spark and then condensed to form metallic aerosol nanoparticles; a gas supply step in which inert gas or nitrogen is supplied between the two metal electrodes; and a metallic aerosol nanoparticle transfer and aggregation step in which the metallic aerosol nanoparticles are carried by the flow of the inert gas or nitrogen and aggregated with one another in the process.

The metallic aerosol nanoparticle generation step of the present invention may comprise a metallic aerosol nanoparticle forming step in which a metallic source material inside a high-temperature furnace is heated and the metal components of the metallic source material are vaporized and then condensed to form metallic aerosol nanoparticles; a gas supply step in which inert gas or nitrogen is supplied in the high-temperature furnace; and a metallic aerosol nanoparticle transfer and aggregation step in which the metallic aerosol nanoparticles are carried by the flow of the inert gas or nitrogen and aggregated with one another in the process.

The metallic aerosol nanoparticle generation step of the present invention may comprise a metallic solution spraying step in which a metallic solution attained by diluting an ionic metal reagent solution in a liquid solvent is sprayed; a metallic aerosol nanoparticle forming step in which the sprayed metallic solution passes through a heating tube by a supplied inert gas or nitrogen and is vaporized and then condensed in the process to form metallic aerosol nanoparticles; and a metallic aerosol nanoparticle transfer and aggregation step in which the metallic aerosol nanoparticles are carried by the flow of the inert gas or nitrogen and aggregated with one another in the process.

The metallic aerosol nanoparticle generation step of the present invention may comprise a metallic solution spraying step in which a metal powder comprising nanoparticles is added to a liquid solvent and sprayed after being diluted into a metallic solution; a metallic aerosol nanoparticle forming step in which the sprayed metallic solution is vaporized by supplied air, inert gas or nitrogen while it passes through a heating tube, so that only pure metal particles remain; and a metallic aerosol nanoparticle transfer and aggregation step in which the metallic aerosol nanoparticles are carried by the flow of the air, inert gas or nitrogen and aggregated with one another in the process.

The size of the aerosol nanoparticles resulting from the metallic aerosol nanoparticle transfer and aggregation step of the present invention is controlled by the flow volume or flow rate of the supplied inert gas or nitrogen.

The metal of the present invention is at least one selected from the group consisting of Pd (palladium), Ni (nickel), Cu (copper), Fe (iron), Ag (silver), Au (gold), Pt (platinum), Co (cobalt) and a combination thereof.

The catalytic surface activation method for electroless deposition of the present invention may further comprise a plating surface treatment step of forming prominence and depression on the plating surface and making it hydrophilic through plasma surface treatment or chemical agent spraying.

The metallic aerosol nanoparticle fixation step of the present invention is may accomplished by colliding the metallic aerosol nanoparticles to the plating surface.

The metallic aerosol nanoparticle fixation step of the present invention is may accomplished by adjusting the temperature of the material to be plated lower than the temperature of the metallic aerosol nanoparticles, so that the aerosol nanoparticles are moved to the plating surface and fixed there.

The metallic aerosol nanoparticle fixation step of the present invention is may accomplished by charging the metallic aerosol nanoparticles with positive or negative charge and moving them toward the material to be plated positioned between two charged electrode plates, so that the metallic aerosol nanoparticles are attracted to one of the electrode plates and fixed there.

And, following the metallic aerosol nanoparticle fixation step of the present invention, the catalytic surface activation method for electroless deposition of the present invention may further comprise a hot pressing step of hot-pressing the material to be plated.

The catalytic surface activation method for electroless deposition of the present invention may further comprise a fixation improving agent treatment step in which the metallic aerosol nanoparticles is mixed with an adhesive solution by spraying following the metallic aerosol nanoparticle generation step, an adhesive solution is applied on the plating surface prior to the metallic aerosol nanoparticle fixation step or an adhesive solution is applied on the plating surface on which the metallic aerosol nanoparticles have been fixed following the metallic aerosol nanoparticle fixation step.

Now referring to the attached drawings, preferred embodiments of the present invention will be described below. The terms and words used in this description and the appended claims are not to be interpreted in common or lexical meaning. Based on the principle that an inventor can adequately define the meanings of terms to best describe his/her own invention, they are to be interpreted in the meaning and concept conforming to the technical concept of the present invention.

Accordingly, it is to be understood that the embodiments and examples given in this description and the drawings are exemplary ones and there may be a variety of equivalents and modifications that may replace them.

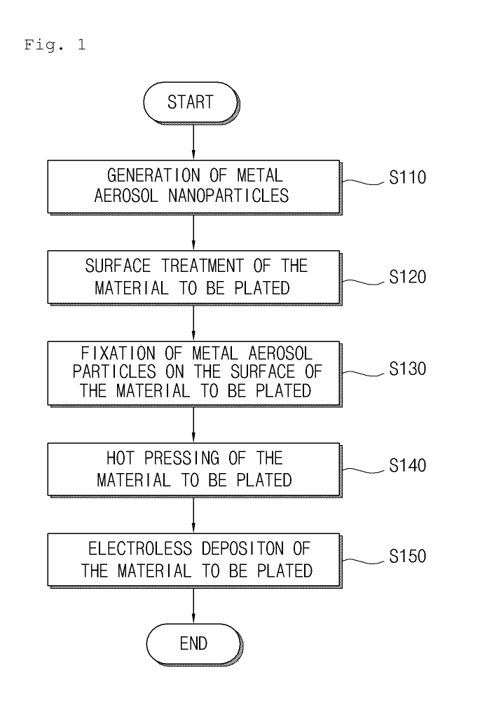

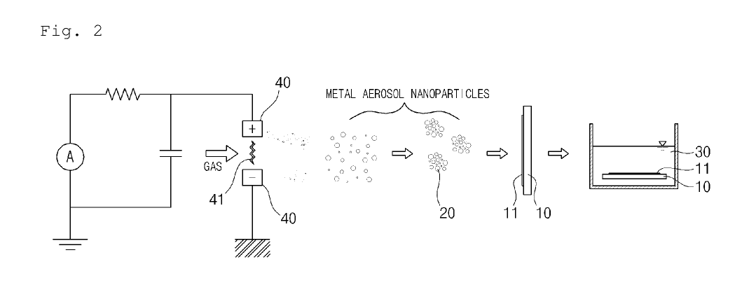

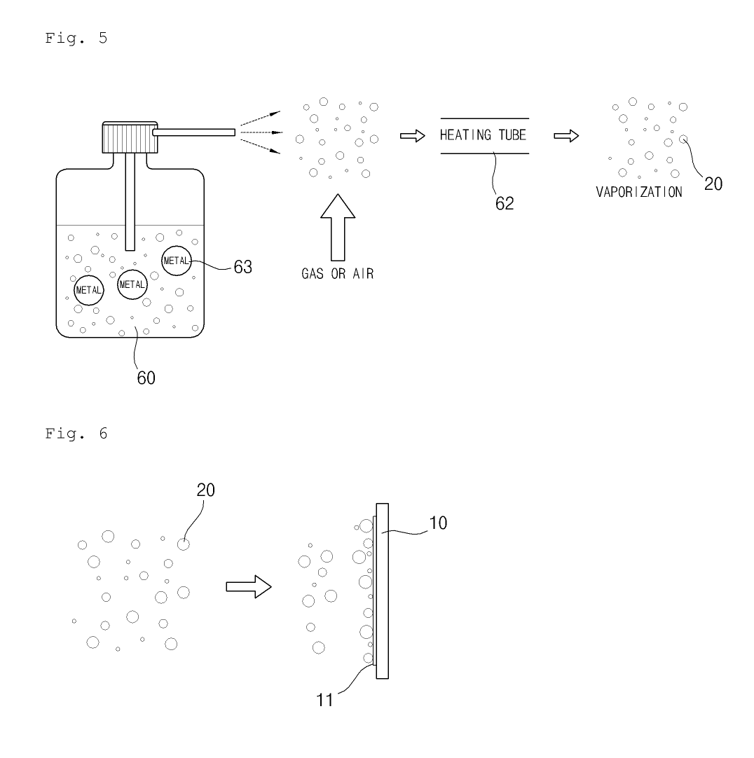

FIG. 1 is a flowchart illustrating the catalytic surface activation method for electroless deposition according to an embodiment of the present invention. FIGS. 2 to 5 illustrate the first to fourth embodiments of the metallic aerosol nanoparticle generation step in FIG. 1. FIGS. 6 to 9 illustrate the first to third embodiments of the metallic aerosol nanoparticle fixation step in FIG. 1. And FIG. 10 illustrates the hot pressing step in FIG. 1.

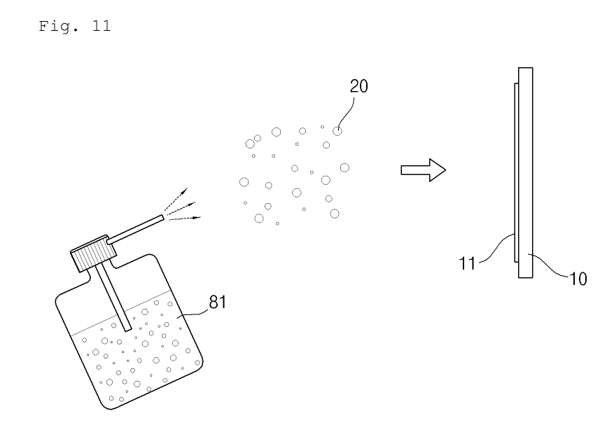

FIGS. 11 to 13 illustrate the first to third embodiments of the fixation improving agent treatment step that may be included in the method of FIG. 1 and FIGS. 14 and 15 illustrate the plating surface treatment step that may be included in the method of FIG. 1.

Now, the catalytic surface activation method for electroless deposition of the present invention will be described in detail, referring to FIGS. 1 to 15.

First, metallic aerosol nanoparticles (20), which are used as plating initiation catalyst in the present invention, are generated (S110).

The metallic aerosol nanoparticle generation step (S110) may be accomplished variously as illustrated in the embodiments of FIGS. 2 to 5.

FIG. 2 illustrates a first embodiment in which the metallic aerosol nanoparticles (20) are generated by applying a high voltage to between metal electrodes (40).

To begin with, a high voltage is applied between two metal electrodes (40) to generate a spark (41). The heat resulting from the spark (41) vaporizes the metal components of the metal electrodes (40), which are condensed to metallic aerosol nanoparticles (20) (step 1a; formation of metallic aerosol nanoparticles).

The spacing between the two metal electrodes (40) may be from 0.5 mm to 10 mm. For example, if the spacing between the metal electrodes (40) is 1 mm, a heat of about 5000° C. is generated when a high voltage of 2.5-3 kV is applied. Then, the metal components of the metal electrodes (40) are vaporized to form the metallic aerosol nanoparticles (20).

The vaporized metallic aerosol nanoparticles (20) may be cooled and condensed as they move from the hot area where the spark (41) has occurred to a cooler area.

The high voltage source may be either a DC (direct current) or AC (alternating current) voltage. In case of AC, the voltage source can be diverse, including square wave, triangular wave, offset wave, etc.

Next, inert gas or nitrogen (N₂) is supplied between the two metal electrodes (40) (step 1b; supply of gas). The inert gas or nitrogen is a stable material with low chemical reactivity with other elements. Thus, it can stably transfer the metallic aerosol nanoparticles (20). The step 1b may be performed during the step 1a or following the step 1a.

Following the step 1b, the metallic aerosol nanoparticles (20) are carried by the flow of the inert gas or nitrogen. In the process, the metallic aerosol nanoparticles (20) may collide with one another and form aggregates (step 1c; transfer of metallic aerosol nanoparticles and aggregation).

The metallic aerosol nanoparticles (20) first formed by the evaporation may have a size of about 10 nm and may grow into larger particles by the collision and aggregation.

The size of the aggregated metallic aerosol nanoparticles (20) may be regulated variously, from nanometers to hundreds of nanometers, with the flow rate or volume of the inert gas or nitrogen. For example, a larger flow volume (or flow rate) of the inert gas or nitrogen results in a less aggregation of the metallic aerosol nanoparticles (20) because the concentration of the particles decreases. In this way, the size of the aggregated metallic aerosol nanoparticles (20) can be reduced. Of course, the particle size and density of the metallic aerosol nanoparticles (20), which act as plating initiation catalyst, can also be changed with the spark generation conditions—applied voltage, frequency, current, resistance, capacitance—, the kind and amount of the inert gas, the shape of the spark electrodes, and so forth.

By controlling the size of the metallic aerosol nanoparticles (20) through the flow of the inert gas or nitrogen, it becomes possible to obtain metallic aerosol nanoparticles (20) with wanted size.

FIG. 3 illustrates a second embodiment of the metallic aerosol nanoparticle generation step (S110) in which a metallic source material (51) is heated at high temperature.

Referring to FIG. 3, a metallic source material (51) in a high-temperature furnace (50) is heated to vaporize the metallic source material (51). The vaporized metal components are condensed and form metallic aerosol nanoparticles (20) (step 2a; formation of metallic aerosol nanoparticles). The heating temperature at which the metallic source material (51) is vaporized may be in the range from 1000 to 2000° C., but is not limited thereto.

Then, inert gas or nitrogen is supplied into the high-temperature furnace (50) (step 2b; supply of gas). The step 2b may be performed during the step 2a or following the step 2a.

Following the step 2b, the metallic aerosol nanoparticles (20) are carried by the flow of the inert gas or nitrogen outside high-temperature furnace (50). In the process, the metallic aerosol nanoparticles (20) collide with one another and form aggregates (step 2c; transfer of metallic aerosol nanoparticles and aggregation). The generation of the metallic aerosol nanoparticles (20) prior to the aggregation is caused by the temperature difference between the high-temperature furnace (50) and outside.

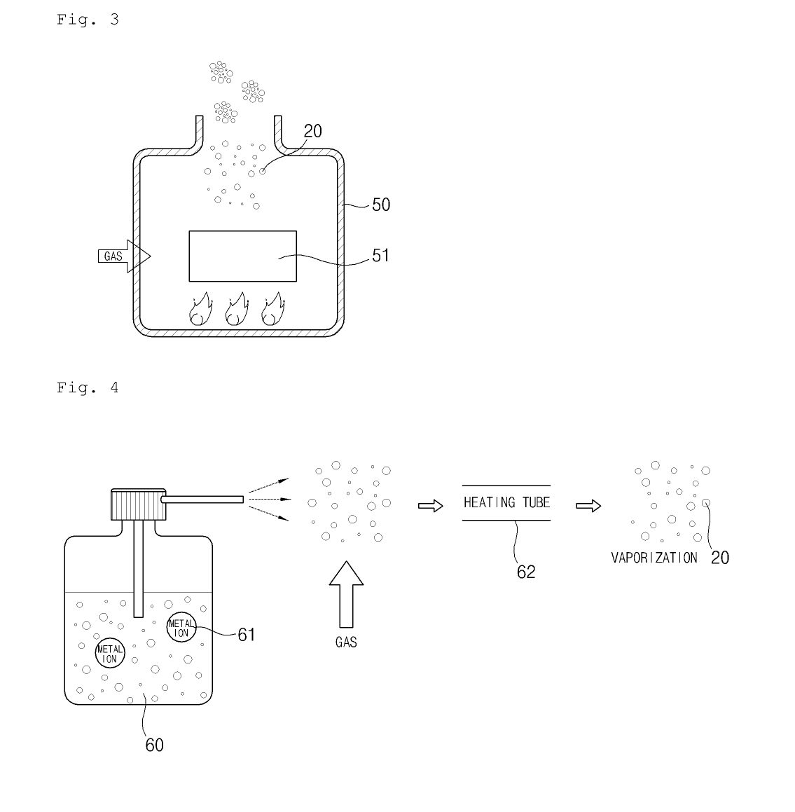

FIG. 4 illustrates a third embodiment of the metallic aerosol nanoparticle generation step (S110) in which an ionic metal reagent solution (61) is used to generate nanoparticles.

First, an ionic metal reagent solution (61) is added to a liquid solvent (60) and the resultant diluted metallic solution is sprayed (step 3a; spraying of metallic solution).

The metal reagent solution may be a reagent solution of palladium, platinum, gold, silver, etc. That is, it may be PdCl₂, H₂PtCl₆, KAu(CN)₂, AgNO₃, and so forth and the Pd, Pt, Au or Ag may be present in the reagent solution in ionic state (Pd²⁺, Pt⁴⁺, Au³⁺ or Ag⁺).

The liquid solvent (60) may be a volatile solvent. It may be water, alcohol or a mixture of water and alcohol. In the liquid solvent (60), a dispersion promoting agent such as polyvinyl alcohol (PVA), polyvinyl pyrrolidone (PVP), polyaniline (PA), etc. may be further added to prevent the aggregation of the metal reagent solution (61) and promote dispersion.

Subsequently, the sprayed metallic solution is carried through a heating tube (62) by inert gas or nitrogen that has been supplied in advance. In the process, the metallic components are vaporized and condensed by low temperature outside heating tube (62) to form metallic aerosol nanoparticles (20) (step 3b; formation of metallic aerosol nanoparticles). That is, the metallic solution is vaporized while it passes through the heating tube (62) at a temperature of, say, 50-150° C. and is condensed by the low temperature (room temperature) outside the tube (62) to form metallic aerosol nanoparticles (20).

Following the step 3b, the metallic aerosol nanoparticles (20) are carried by the flow of the inert gas or nitrogen. In the process, the metallic aerosol nanoparticles (20) collide with one another and form aggregates (step 3c; transfer of metallic aerosol nanoparticles and aggregation).

FIG. 5 illustrates a fourth embodiment of the metallic aerosol nanoparticle generation step (S110) in which metal powder (63) is used to generate aerosol nanoparticles.

Referring to FIG. 5, metal powder (63) comprising nanoparticles is added to a liquid solvent (60) and the resultant diluted metallic solution is sprayed (step 4a; spraying of metallic solution).

Next, the sprayed metallic solution is carried through a heating tube (62) by air, inert gas or nitrogen that has been supplied in advance. In the process, the liquid component is evaporated and pure metallic particles remain to form metallic aerosol nanoparticles (20) (step 4b; formation of metallic aerosol nanoparticles).

That is, the liquid component is evaporated while the sprayed metallic solution passes through the heating tube (62) at a temperature of, say, 50-150° C. and pure metallic particles remain to form metallic aerosol nanoparticles (20).

Again, the liquid solvent (60) may be a volatile solvent. It may be water or alcohol and, in the liquid solvent (60), a dispersion promoting agent such as polyvinyl alcohol (PVA), polyvinyl pyrrolidone (PVP), polyaniline (PA), etc. may be further added to and promote the dispersion of the metal powder (63).

Following the step 4b, the metallic aerosol nanoparticles (20) are carried by the flow of the air, inert gas or nitrogen. In the process, the metallic aerosol nanoparticles (20) collide with one another and form aggregates (step 4c; transfer of metallic aerosol nanoparticles and aggregation).

Of course, in the second to fourth embodiments illustrated in FIGS. 3 to 5, the size of the aggregated metallic aerosol nanoparticles (20) may be regulated variously, from nanometers to hundreds of nanometers, with the flow rate or volume of the inert gas or nitrogen, as in the first embodiment.

The metallic components used in the four embodiments illustrated in FIGS. 2 to 5 may be at least one selected from the group consisting of Pd (palladium), Ni (nickel), Cu (copper), Fe (iron), Ag (silver), Au (gold), Pt (platinum), Co (cobalt) and a combination thereof.

And, the inert gas may be argon (Ar), helium (He), neon (Ne), krypton (Kr), xenon (Xe), radon (Ra), and so forth.

Following the metallic aerosol nanoparticle generation step (S110) illustrated in FIGS. 2 to 5, the resultant metallic aerosol nanoparticles (20) is fixed on the plating surface (11) of the material to be plated (10) (S130). The material to be plated (10) may be a circuit board used to manufacture various devices, but is not limited thereto.

The metallic aerosol nanoparticle fixation step (S130) may be performed variously as illustrated in the first to third embodiments of FIGS. 6 to 9.

FIG. 6 illustrates collision fixation in which the metallic aerosol nanoparticles (20) are fixed on the plating surface (11) of the material to be plated (10) by collision. Here, the collision of the metallic aerosol nanoparticles (20) may be a natural collision by the flow of the inert gas or nitrogen or a collision by external force.

In case the material to be plated (10) is a porous plate, gaseous components such as the inert gas or nitrogen may leave through the pores of the plate while the metallic aerosol nanoparticles (20) are fixed on the plating surface (11) of the material to be plated (10) by collision and diffusion along the surface.

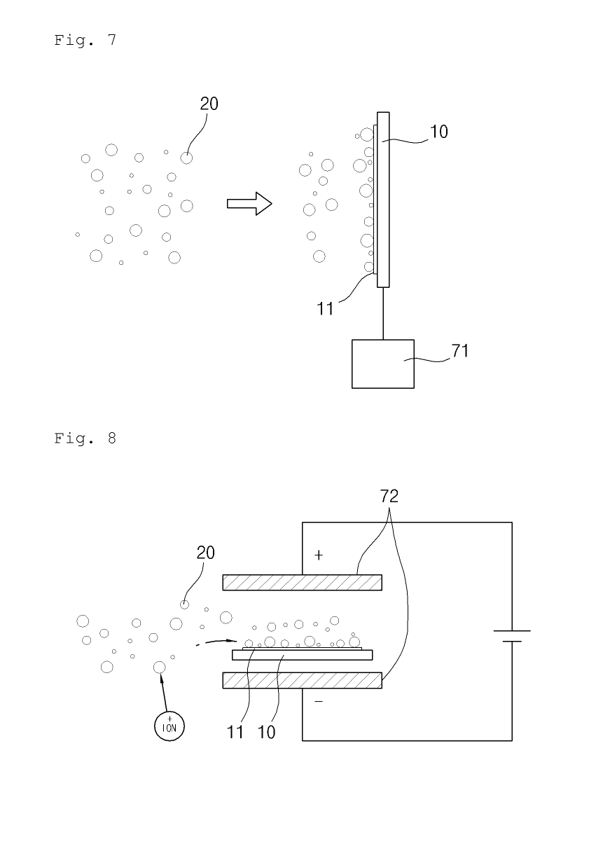

Next, FIG. 7 illustrates thermal migration, namely thermophoretic deposition, or the fixation of the metallic aerosol nanoparticles (20) on the plating surface (11) of the material to be plated (10) by spontaneous migration from high to low temperature using a temperature control device (71).

That is, the metallic aerosol nanoparticle (20) fixation is accomplished by adjusting the temperature of the material to be plated (10) lower than the temperature of the metallic aerosol nanoparticles (20),

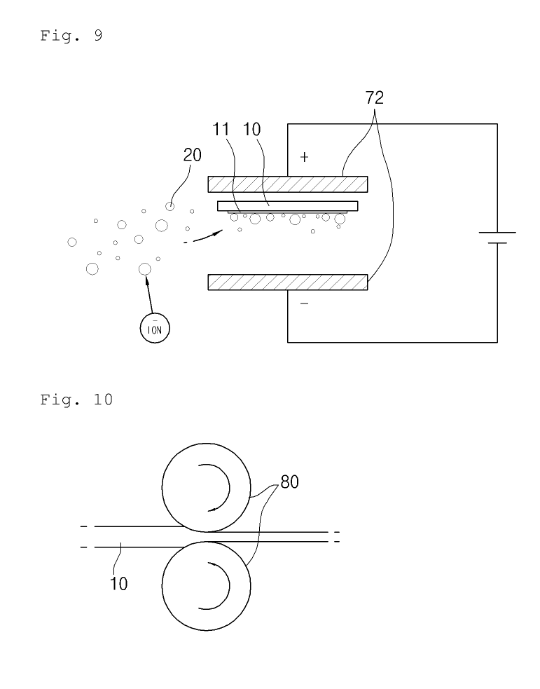

FIG. 8 and FIG. 9 illustrate a method utilizing an electric field formed between electrode plates (72). Metallic aerosol nanoparticles (20) charged with positive (FIG. 8) or negative (FIG. 9) charge are moved to the material to be plated (10) between two electrode plates (72). Then, the metallic aerosol nanoparticles (20) are attracted to one of the two electrode plates (72) and fixed on the plating surface (11) of the material to be plated (10).

As aforementioned, a variety of methods as those illustrated in FIGS. 7 to 9 may be applied to fix the metallic aerosol nanoparticles (20) on the plating surface (11) of the material to be plated (10).

Following the metallic aerosol nanoparticle fixation step (S130), the material to be plated (10) is impregnated in an electroless deposition solution (30) to form a plating layer on the plating surface (11) on which the metallic aerosol nanoparticles (20) are fixed (S150).

In the electroless deposition step (S150), the plating component of the electroless deposition solution (30) deposited by the metallic aerosol nanoparticles (20) is coated on the plating surface (11) of the material to be plated (10) to form a plating layer on the plating surface (11). A detailed description of the electroless deposition process will be omitted, since it is a well-known technique.

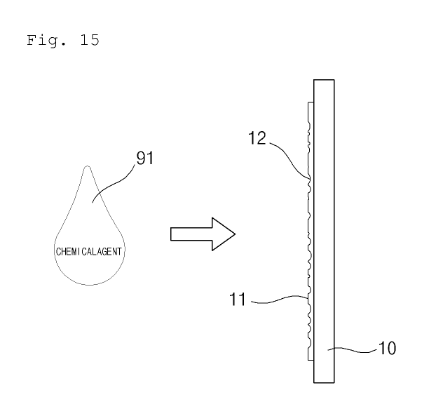

The method of the present invention may further comprise a plating surface treatment step (S120) illustrated in FIG. 14 or 15 in order to improve the fixation efficiency of the metallic aerosol nanoparticles (20) on the plating surface (11) of the material to be plated (10).

The plating surface (11) of the material to be plated (10) may be surface treated with plasma (90) as in FIG. 14 or with a chemical agent (91) as in FIG. 15. As a result, part of the plating surface (11) is peeled off to form prominence and depression (12) and increase hydrophilicity. With increased friction, the prominence and depression (12) may improve the fixation force and fixation efficiency of the metallic aerosol nanoparticles (20) and the plating characteristics can be improved by the enhanced hydrophilicity.

The chemical agent (91) may be a strong acid or a strong base. For example, it may be sodium hydroxide (NaOH), nitric acid (HNO₃), hydrochloric acid (HCl), sulfuric acid (H₂SO₄), and so forth.

Of course, the plating surface treatment step (S120) may be performed at any point of time prior to the metallic aerosol nanoparticle fixation step (S130).

Also, the method in accordance with the present invention may further comprise a fixation improving agent treatment step as illustrated in FIGS. 11 to 13 in order to improve the fixation or adhesion force of the metallic aerosol nanoparticles (20) to the plating surface (11) of the material to be plated (10).

FIG. 11 illustrates a method in which, following the metallic aerosol nanoparticle generation step (S110), the resultant metallic aerosol nanoparticles (20) is mixed with an adhesive solution (81) by spraying. During the following metallic aerosol nanoparticle fixation step (S130), the mixture of the metallic aerosol nanoparticles (20) and the adhesive solution is fixed on the plating surface (11) of the material to be plated (10) at the same time.

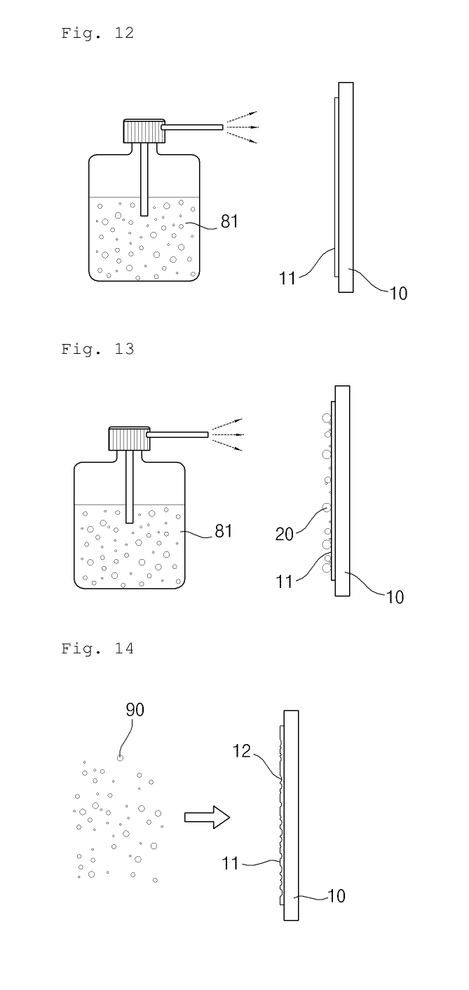

FIG. 12 illustrates a method in which an adhesive solution (81) is applied on the plating surface (11) prior to the metallic aerosol nanoparticle fixation step (S130). Before the metallic aerosol nanoparticles (20) are fixed on the plating surface (11), the adhesive solution (81) is applied on the plating surface (11) in order to enhance the fixation force of the metallic aerosol nanoparticles (20).

FIG. 13 illustrates a method in which, following the metallic aerosol nanoparticle fixation step (S130), an adhesive solution (81) is applied on the plating surface (11) on which the metallic aerosol nanoparticles (20) have been fixed. The adhesive solution (81) is applied on the plating surface (11) on which the metallic aerosol nanoparticles (20) have been fixed in order to enhance the fixation force.

The adhesive solution (81) used in the methods illustrated in FIGS. 11 to 13 may be a polymer resin dissolved in water or any other adhesive material that can be sprayed.

The method in accordance with the present invention may further comprise a hot pressing step (S140) of, following the metallic aerosol nanoparticle fixation step (S130), hot-pressing the material to be plated (10) using a press roller (80) illustrated in FIG. 10.

The temperature at which the hot pressing is performed may be a temperature higher than room temperature. The upper limit of the temperature may be different depending on the kind of the material to be plated (10). A temperature that does not lead to the deformation of the material to be plated (10) is allowed. Of course, a temperature that does not lead to the deformation of the fixation improving agent and the metallic aerosol nanoparticles (20) is preferable.

In addition to further enhancing the fixation force of the fixed metallic aerosol nanoparticles (20), the hot pressing step (S140) provides the effect of evaporating various impurities including moisture by heating.

The method in accordance with the present invention is environment-friendly with no wastewater generation because the generation of metallic aerosol nanoparticles (20) required for the catalytic activation of the plating surface (11) of the material to be plated (10) in an electroless deposition process is performed in a dry system.

Also, since the plating initiation catalyst is prepared and provided in the form of aerosol, the method of the present invention can be applied to materials with various and complicated shapes. Also, a continuous and quick process can be attained.

Besides, any conductive materials can be prepared into nanoparticles and the particle characteristics can be easily controlled through simple electric or fluid dynamical manipulation. Further, it is possible to prepare metallic aerosol nanoparticles with various particle size distributions.

The method of the present invention can be applied in various fields requiring electroless deposition, including semiconductor, packaging, household appliances, digital media, display electronics, environmental application, energy technology, and so forth.

The catalytic surface activation method for electroless deposition according to the present invention is applicable to large-scale plating with simple process and superior applicability, improves the plating characteristics with little impurity generation, requires no post-treatment process for removing impurities and is environment-friendly with no wastewater generation by directly fixing metallic aerosol nanoparticles on the material to be plated.

While the present invention has been described in detail with reference to the preferred embodiments, those skilled in the art will appreciate that various modifications and substitutions can be made thereto without departing from the spirit and scope of the present invention as set forth in the appended claims.

What is claimed is:

1. The catalytic surface activation method for electroless deposition comprising:
a metallic aerosol nanoparticle generation step of generating metallic aerosol nanoparticles, which act as plating initiation catalyst;
a metallic aerosol nanoparticle fixation step of fixing the resultant metallic aerosol nanoparticles on the plating surface; and
an electroless deposition step of impregnating the material to be plated in an electroless deposition solution and forming a plating layer on the plating surface on which the metallic aerosol nanoparticles are fixed; and
wherein the metallic aerosol nanoparticle generation step comprises:
a metallic aerosol nanoparticle forming step in which a metallic source material inside a high-temperature furnace is heated and the metal components of the metallic source material are vaporized and then condensed to form metallic aerosol nanoparticles;
a gas supply step in which inert gas or nitrogen is supplied in the high-temperature furnace; and
a metallic aerosol nanoparticle transfer and aggregation step in which the metallic aerosol nanoparticles are carried by the flow of the inert gas or nitrogen and aggregated with one another in the process.

2. The catalytic surface activation method for electroless deposition as set forth in claim 1, wherein the metallic aerosol nanoparticle fixation step is accomplished by adjusting the temperature of the material to be plated lower than the temperature of the metallic aerosol nanoparticles, so that the aerosol nanoparticles are moved to the plating surface and fixed there.

3. The catalytic surface activation method for electroless deposition as set forth in claim 1, wherein the metal is at least one selected from the group consisting of Pd (palladium), Ni (nickel), Cu (copper), Fe (iron), Ag (silver), Au (gold), Pt (platinum), Co (cobalt) and a combination thereof.

4. The catalytic surface activation method for electroless deposition as set forth in claim 1, wherein the size of the aerosol nanoparticles resulting from the metallic aerosol nanoparticle transfer and aggregation step is controlled by the flow volume or flow rate of the supplied inert gas or nitrogen.
